(19) United States
(12) Patent Application Publication
(10) Pub. No.: US 2015/0146295 A1
(43) Pub. Date: May 28, 2015

(54) LASER ENERGY OUTPUT CONTROL APPARATUS AND METHOD THEREOF

(71) Applicant: U&U Engineering Inc., Taoyuan (TW)

(72) Inventors: Wen-Chih Weng, Taoyuan (TW); Ming Chen, Taoyuan (TW); Hsiao Yen Chuang, Taoyuan (TW)

(73) Assignee: U&U Engineering Inc., Taoyuan (TW)

(21) Appl. No.: 14/164,300

(22) Filed: Jan. 27, 2014

(30) Foreign Application Priority Data
Nov. 28, 2013 (TW) 102143599

(51) Int. Cl. G02B 27/28; G02B 26/02

(52) U.S. Cl. CPC G02B 27/283; G02B 26/023
USPC 359/489.08

(57) ABSTRACT

A laser output apparatus is disclosed. The laser output apparatus includes a laser source providing a first laser light; a first attenuation element attenuating the first laser light to be a second laser light having a polarization direction and an energy; a polarization changing element changing the polarization direction; and a second attenuation element decreasing the energy.

### CROSS-REFERENCE TO RELATED APPLICATION AND CLAIM OF PRIORITY

This application claims the benefit of Taiwan Patent Application No. 102143599, filed on Nov. 28, 2013, at the Taiwan Intellectual Property Office, the disclosures of which are incorporated herein in their entirety by reference.

### BACKGROUND

1. Field of the Invention

The present invention relates to a laser apparatus, and more particularly to a laser energy output control apparatus.

2. Description of the Related Art

The currently known laser energy output control apparatus includes a laser source 101, a half-wave plate 102 and a polarizer 103 (as shown in FIG. 1). The half-wave plate 102 itself has an optical characteristic that when the polarization direction (generally defined by the direction of the electric field) of a linearly polarized laser beam forms an angle of θ with the optical axis of the half-wave plate 102, the polarization direction of the beam passing through the half-wave plate 102 will be relatively rotated by 2θ (as shown in FIG. 2).

After the half-wave plate 102, there is a polarizer 103 as shown in FIG. 1. The laser beam passes through the polarizer 103 and is split into two beams, which are p-polarized (parallel to the transmission axis of the polarizer 103) and s-polarized (perpendicular to the transmission axis of the polarizer 103) and perpendicular to each other. If the p-polarized component is selected to be the output light beam, the strength of the p-polarized component may be changed by adjusting the relative angle between the polarization direction of the incident beam and the optical axis of the polarizer, and, optionally, the s-polarized component may correspondingly enter the beam stop 104 to be dumped.

The currently known apparatus mentioned above can achieve the purpose of continuously controlling the energy output. However, the commercial products or assemblies actually applying the above principle, encounter limitations in use. For example, the manual rotary base commonly used to rotate the wave plate can only applied to the scheme which has a long-term unchanged recipe and needs to be adjusted only one time during the laser machining process. If the output energy needs to be adjusted any time during the laser machining process, e.g., different regions on a workpiece need different machining energy intensity, it is inadequate to use the manual rotary base. Also, according to theory, with the laser output from the fully open (100%) to the fully closed (0%), there is only a 45-degree angle of the wave plate rotation. If a reasonable resolution order of more than 200 steps within the 45-degree angle is desired, the manually rotating mechanism has limits to the accuracy and reliability of any manual adjustment.

There is another business assembly using an electric rotary base to replace the manual rotary base. Practitions buy an existing electric rotary base, and mount the existing electric rotary base and the back-end polarizer to the same base. To control the electric rotary base, a motor driver is purchased separately to drive the electric rotary base, and has only a simple forward/reverse driving function such that the energy is increased or decreased with the forward/reverse rotation. However, such an assembly does not have the functions of energy zero/highest point correction or absolute energy unit and scale calibration.

Also as mentioned above, even if using the electric rotary base can increase the resolution and reliability and provide a real-time control, it still has its limitations on some occasions of laser micromachining. For example, in the case of a laser repairing of flat panel display, the laser may need ˜mJ (roughly milli joule level power) to cut the metal rails, but the subsequent action may need only ˜10 μJ (roughly 10 micro joule level power) to precisely strip away indium tin oxide (ITO) or a passivation layer. The energy and process window required by the former is 100 multiple orders of magnitude from that required by the latter, and the stability of the laser source output is typically around +/−5%. Thus, in terms of mechanical design, it is meaningless to try to reach the resolution and precision control by entirely relying on the rotary base within 45 degrees. That is, if the resolution has 500 graduations and the process window has a margin of +/−20 during the ˜mJ machining, when setting the graduation to 2 of the 500 graduations, even the variation of the laser itself exceeds the setting, not to mention finding the process window.

Therefore, it is necessary to develop an integrated and compact laser energy output control module which can provide immediate and continuous energy output control and simultaneously switch between different “gears” in concert with the process window. In addition, it can be directly controlled by an ordinary PC communications port (COM port) or Universal Serial Bus port (USB port) without additional driving circuits or axis cards, and could be conveniently used by typical laser processing equipment manufacturers or end customers.

In order to overcome the drawbacks in the prior art, a laser energy output control apparatus and method is disclosed. The particular design in the present invention not only solves the problems described above, but is also easy to implement. Thus, the present invention has utility for the industry.

### SUMMARY OF THE INVENTION

The apparatus of the present invention is an integrated module, which includes optical lenses, servo/stepper motors, motion mechanisms, a mechanical outer shell, and a circuit board with a single-chip microcomputer and the motor driving circuit therein (with a size equivalent to the overall module and directly mounted on the module), and the associated firmware and algorithms.

In accordance with an aspect of the present invention, a laser output apparatus is provided. The laser output apparatus includes a laser source providing a first laser light; a first attenuation element attenuating the first laser light to be a second laser light having a polarization direction and an energy; a polarization changing element changing the polarization direction; and a second attenuation element decreasing the energy.

In accordance with another aspect of the preset invention, a laser outputting method is provided. The laser outputting method includes providing a first laser light; attenuating the first laser light to be a second laser light having a first polarization direction and a first energy; changing the first polarization direction; and decreasing the first energy.

The above objectives and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows a schematic diagram of the conventional laser output energy control apparatus;

FIG. 2 shows a schematic diagram of the conventional half-wave plate;

FIGS. 3(a) and 3(b) show a schematic diagram of the conventional laser output energy control apparatus;

FIG. 4 shows a schematic diagram of the laser output energy control apparatus according to an embodiment of the present invention.

FIG. 5 shows the relationship between the output intensity and the angle according to the Malus' Law;

FIG. 6 shows a schematic diagram of the modular design; and

FIG. 7 shows a schematic diagram where the axis height of the laser remains the same when the same two modules are connected in series.

### DETAILED DESCRIPTION

The present invention will now be described more specifically with reference to the following embodiments. It is to be noted that the following descriptions of preferred embodiments of this invention are presented herein for the purposes of illustration and description only; they are not intended to be exhaustive or to be limited to the precise form disclosed.

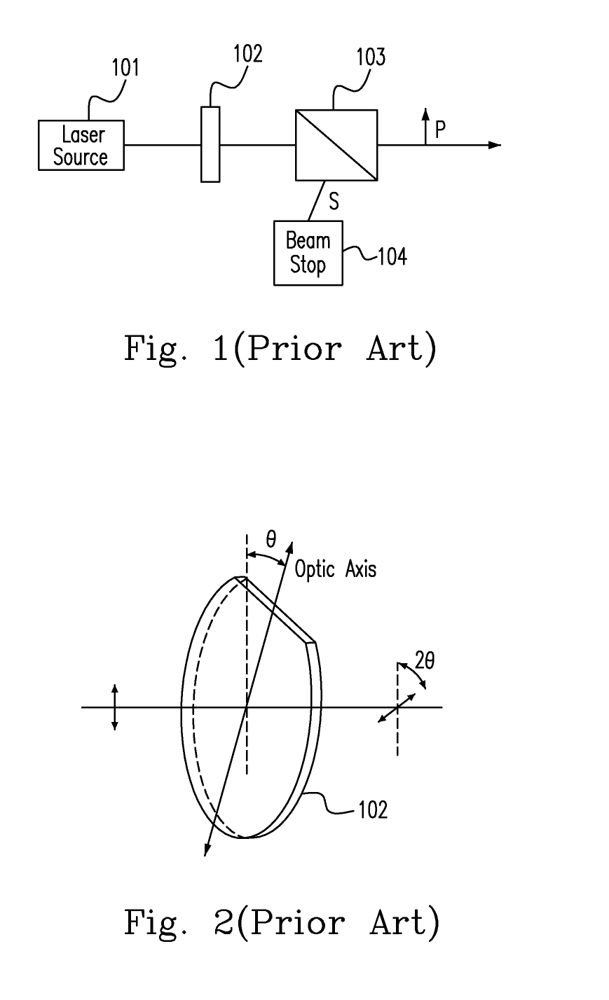

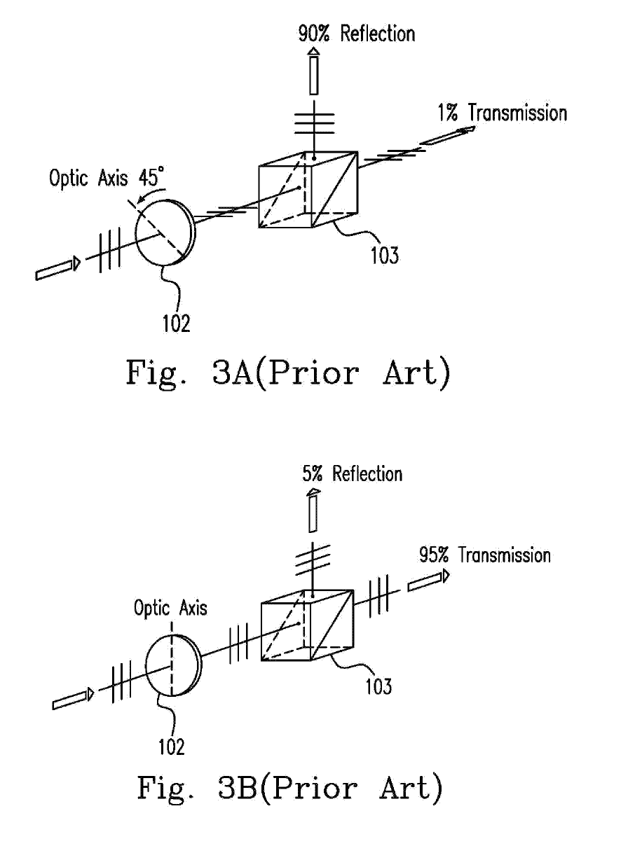

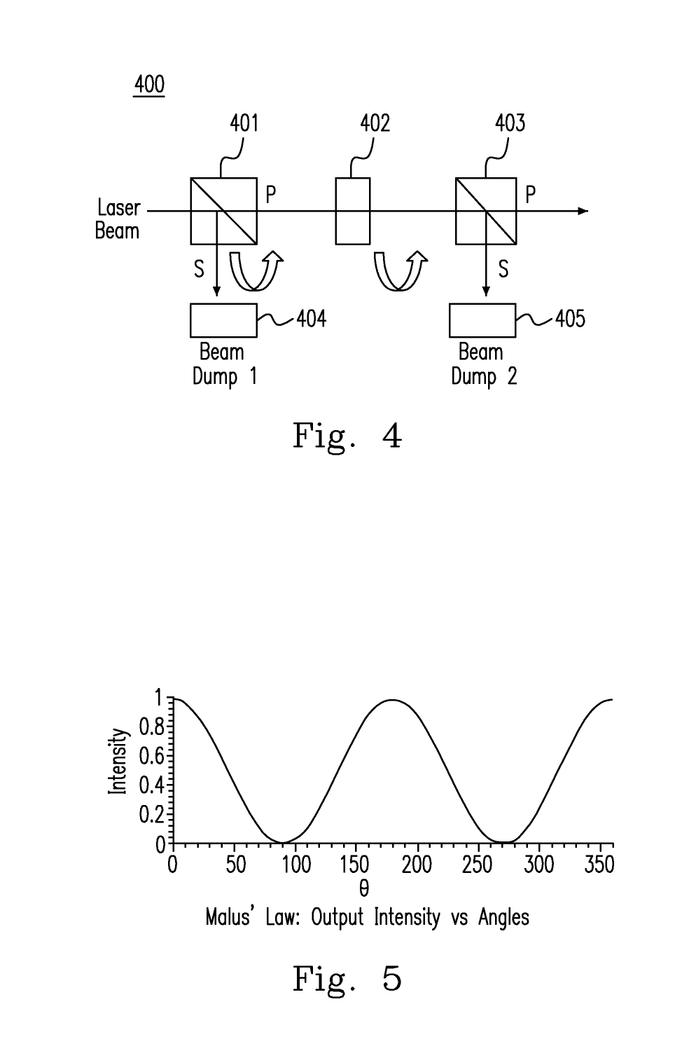

Please refer to FIG. 4, which shows a schematic diagram of a laser output energy control apparatus 400 according an embodiment of the present invention, wherein a first polarizer 401, a half-wave plate 402, a polarizer 403, and beam stops 404 and 405 are included. That is, an attenuation element is positioned in front of the conventional half-wave plate and polarizer combination shown in FIG. 1 to reduce the laser beam to a lower energy level. Preferably, the attenuation element can be implemented by the rotatable first polarizer 401, and the half-wave plate 402 can be replaced by other elements which can change the polarization direction of the laser light. The first polarizer 401, the half-wave plate 402, the second polarizer 403 may be optionally disposed on a rotating base (not shown) to rotate the relative positions thereof. Before the laser beam enters the combination of the half-wave plate 402 and the second polarizer 403, a portion of the energy of the laser beam is refracted due to the rotation angle of the polarizer 401 in order to pre-reduce the energy of the laser beam as “low-gear” without influencing the stability of the energy of the laser beam. When higher energy is needed, the first polarizer 401 automatically rotates back to the original position, or the position that causes less laser energy to be refracted, as “high-gear.” The polarization direction of the laser light passing through the first polarizer 401 will, of course, be rotated due to the rotation of the first polarizer 401. However, the mechanical design of the present invention allows the half-wave plate 402 to make a 360 degree rotation (as the principle shown in FIG. 2), so that the laser beam enters the second polarizer 403 with a 100% P polarization direction or a 100% S polarization direction. With the circuit and firmware disclosed hereafter, the zero/highest point of energy of the output laser can be adjusted and saved. The beam refracted by the polarizer 401 or the second polarizer 403 is guided to the beam dump 404 or 405 to be discarded, or to other elements based on application.

For example, if the output energy of a laser source is about 1 mJ, and the interval between the zero point and the highest point of the energy of the output laser is divided into 500 graduations, i.e., 2 μJ per graduation, the energy variation of the actual output of the laser source is about 1000 μJ±50 μJ with respect to the laser source having a stability of ±5%. Such a variation in the magnitude exceeds the energy scale of 2 μJ which can be adjusted by each graduation. This can be acceptable to the laser machining process on the order of ˜mJ. However, with respect to the laser machining process on the order of ˜μJ, even the variance of the laser itself is larger than the energy scale set by a single graduation, and therefore such a detailed graduation scale is meaningless. Therefore, the original laser device using the conventional method is not applicable, but must use another laser device customized for ˜μJ. However, for the embodiment described above, if the present invention is adjusted to “low gear”, e.g., the first polarizer 401 refracts 99% of the laser beam while only letting 1% of the laser beam pass, the energy of the laser light passing through the polarizer 401 is about 10 μJ±0.5 μJ (whose variability is less than the energy scale 2 μJ which can be adjusted by one single graduation) by considering laser stability ±5%. Therefore, the laser energy can be finely tuned by using the graduations to adapt to the ˜μJ machining process. When encountering a ˜mJ machining process, the polarizer 401 can be adjusted to refract a small portion of the laser beam and let most of the laser beam pass, and the apparatus then operates in a “high gear” state, so the apparatus can be used for the ˜mJ machining process. Thus, by switching between the “high gear” and the “low gear”, the present invention can be used in any machining processes requiring various levels of energy that can have of quite different orders of magnitude.

This design has three advantages when used with practical applications:

1. In a production line, the absolute units, such as milli Joule or Watt, of all the production parameters of the laser machining process machine can be unified. For current commercially available laser sources, there are minor differences among the generated laser no matter which oscillating crystals are used, such as YAG, YVO4, or YLF. In addition, the Q switches and the frequency multipliers are all made of crystals. Thus, there are substantial differences among the highest/optimal output energy of the laser sources. In practice, each laser machining process machine always has its own “graduation scale.” Even with the conventional combination of the half-wave plate and the polarizer, because the output laser is non-linear according to Malus' Law (FIG. 5), the graduation scale is not available using a simply shift. That is to say, different machines require different formulation set to achieve the same machining process results. Another disadvantagous control method adjusts the excitation voltage of the laser sources so as to make the highest energy of the output of all the laser sources the same. Because this will cause a deterioration in related parameters, such as modal, stability, lifetime and other parameters, this method is not recommended by laser source manufacturers. The outputs of different laser machines can be unified according to absolute units (such as milli Joule or Watt) using the apparatus of the present invention without influencing the performance of the laser source.

2. All laser sources will decay with time depending on the frequency of use. Under the premise that the solution is to not adjust the laser source, the apparatus can reserve margin to compensate the decay.

3. Another characteristic is described as follows. In many occasions of micromachining, especially in the UV frequency band, only energy of ˜10 μj is needed for an area size of ˜μm×μm, and the process window is also within the order of magnitude. The minimum energy of an ordinary commercially available laser source is around ˜mJ or above 1W. Because the oscillation of laser sources has a lower limit, the output energy of the laser sources can not be arbitrarily reduced. In addition, although the resolution can be increased through the gears, etc. when using the conventional combination of the half-wave plate and the polarizer mentioned above, it is meaningless if the relative variation of the laser source output is greater than 5%. However, the apparatus of the present application can linearly reduce the energy of the output laser without influencing the variation, so that users can easily apply the machining parameters and the wider process window.

Preferably, the present invention can be implemented with a servo/stepper motor to drive a low backlash worm gear in a mechanical design, and control the energy of the output laser beam through the combination of the half-wave plate and the polarizer through the half-wave plate spurred by a motor according to the principles previously described. A reasonable (as the aforementioned, a very high mechanical resolution is not meaningful) resolution of ˜1000 (roughly 1000) between the zero point and the highest point of the output energy can be achieved using the worm gear box and the selection of worm gears and gearwheels.

As to the first polarizer, there are two ways to implement:

1. Manually Adjust the Rotation:

Mount the polarizer on a rotating base, and manually adjust the rotation angle, or

2. Electrically Adjust the Rotation:

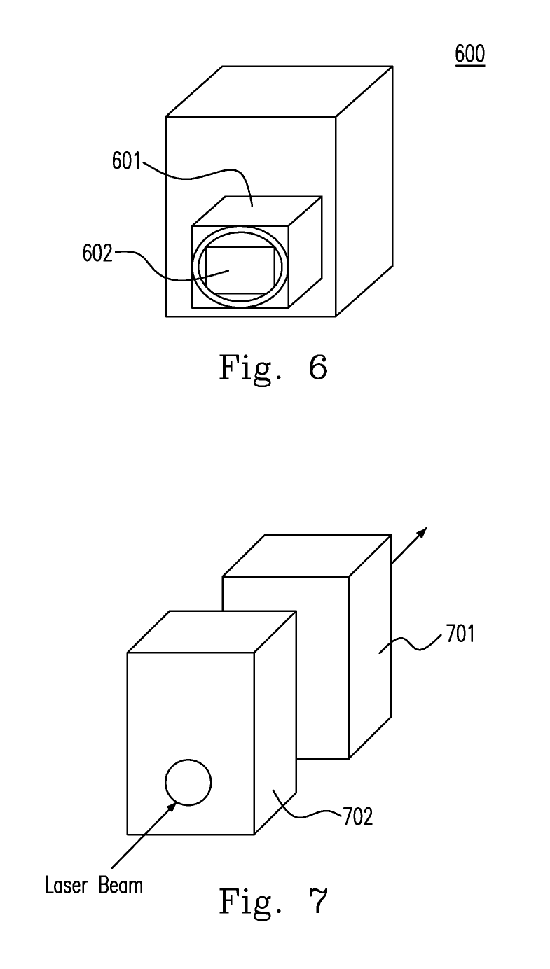

The above mechanical design use a modular design. Therefore, another embodiment may include a module with an identical module in front where the half-wave plate is replaced by a polarizer, as shown in FIG. 6, wherein the module body 600 includes a rotating device 601 and a first polarizer 602. Because it is completed by connecting of two the same modules in series, the axis height of the laser remains the same as shown in FIG. 7, wherein the half-wave plate of the module 702 is replaced with a polarizer and connects to another module 701 in series, and the half-wave plate of the module 701 maintains the status without being replaced by a polarizer. FIG. 7 shows that the axis height of the laser is not affected.

Furthermore, the firmware and various correction calculation functions are completed by the control circuit, as described below.

The control circuit and the module are similar in size, and the control circuit can be mounted directly on the module. The circuit mainly consists of a single-chip microprocessor and a motor driven IC. There are ports, such as RS-232 or USB, to communicate with an external unit. The user can simply use ASCII commands or a sprogram library to use HyperTerminal or code in their main program without involving complex motor control circuit or purchasing additional motor drive axis cards . . . etc.

There is built-in firmware with a calculation and correction function controlled by the user through a simple procedure. The basic commands are the following:

| Command | Function |
|---|---|
| Attenuator Parameter | Set the number of steps |
| Home Motor | Return the machine to the original state |
| Calibration Min | Set the zero point of energy |
| Calibration Max | Set the highest point of energy |
| Calibration 1~20 | Set the middle point of energy |
| Shutter OpenClose/SH | Driving solenoid at the zero point of |
| Status Inquiry SH? | energy to ensure no leaked laser |
| Jog Positive | Perform one positive rotating step |
| Jog Negative | Perform one negative rotating step |
| Built-in look up table | Built-in look up table |

Take setting the zero point of energy for example. After a user turns on the laser source and the light beam passes through the apparatus, a laser power/energy meter is engaged, the apparatus is rotated by a step motor or in a step manner, and the value of the meter is read at the same time to ensure the lowest point of energy. The command “Calibration Min” is used to memorize the position of the lowest point of energy to complete the correction. The highest and the middle point of energy are calibrated in the same way. It is not necessary to change the optimal parameters or the highest output energy of the laser source, nor is it necessary to change or adjust the polarizer such that the energy of the output laser can be controlled continuously by an ordinary PC.

### Embodiments

1. A laser output apparatus comprises a laser source providing a first laser light; a first attenuation element attenuating the first laser light to be a second laser light having a polarization direction and an energy; a polarization changing element changing the polarization direction; and a second attenuation element decreasing the energy.

2. The laser output apparatus of Embodiment 1, wherein the first attenuation element is a first polarizer, the polarization changing element is a half-wave plate, and the second attenuation element is a second polarizer.

3. The laser output apparatus of any one of Embodiments 1-2, wherein the second laser light has a propagation direction and a component, and the second polarizer refracts the component to decrease the energy.

4. The laser output apparatus of any one of Embodiments 1-3, wherein the first laser light passes through the first polarizer, the half-wave plate and the second polarizer along the propagation direction.

5. The laser output apparatus of any one of Embodiments 1-4, wherein the propagation direction defines a rotating axis, and the first polarizer rotates around the rotating axis and refracts the component of the first laser light to attenuate the first laser light and generate the second laser light.

6. The laser output apparatus of any one of Embodiments 1-5, wherein the half-wave plate rotates around the rotating axis to change the polarization direction.

7. The laser output apparatus of any one of Embodiments 1-6 further comprises a first rotating base and a second rotating base, wherein the first polarizer and the half-wave plate are respectively configured on the first rotating base and the second rotating base.

8. The laser output apparatus of any one of Embodiments 1-7 further comprises a motor and a worm gear, wherein the motor and the worm gear rotate the first rotating base and the second rotating base by gear driving so as to rotate the first polarizer and the half-wave plate respectively configured on the first rotating base and the second rotating base.

9. The laser output apparatus of any one of Embodiments 1-8, wherein the motor is a step motor.

10. A laser outputting method comprises providing a first laser light; attenuating the first laser light to be a second laser light having a first polarization direction and a first energy; changing the first polarization direction; and decreasing the first energy.

11. The laser outputting method of Embodiment 10, wherein the attenuating step further comprises steps of splitting the first laser light into a first polarization component and a second polarization component, wherein the second laser light is one of the first polarization component and the second polarization component.

12. The laser outputting method of any one of Embodiments 10-11, wherein the first laser light has a second polarization direction, and the splitting step further comprises steps of providing a polarizer having a transmission axis; rotating the polarizer such that there is a relative angle between the second polarization direction and the transmission axis; and making the first laser light passing through the polarizer to generate the first and the second polarization components.

13. The laser outputting method of any one of Embodiments 10-12, wherein the changing step further comprises steps of providing a half-wave plate; and changing the first polarization direction by rotating the half-wave plate.

14. The laser outputting method of any one of Embodiments 10-13, wherein the changing step further comprises a step of rotating the half-wave plate by using a motor and a worm gear in a gear driving manner.

15. The laser outputting method of any one of Embodiments 10-14, wherein the decreasing step further comprises steps of providing a second polarizer; and decreasing the first energy using the second polarizer.

16. The laser outputting method of any one of Embodiments 10-15, wherein the decreasing step further comprises a step of rotating the second polarizer by using a motor and a worm gear in a gear driving manner.

17. The laser outputting method of any one of Embodiments 10-16, wherein the decreasing step further comprises a step of taking the energy-decreased second laser light as an output laser.

18. The laser outputting method of any one of Embodiments 10-17, wherein the output laser has a lowest energy value, a zero point of energy, a highest energy value, and a highest point of energy, the method further comprising a step of measuring the lowest energy value to determine the zero point of energy, and the highest energy value to determine the highest point of energy using a step motor.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A laser output apparatus, comprising:
a laser source providing a first laser light;
a first attenuation element attenuating the first laser light to be a second laser light having a polarization direction and an energy;
a polarization changing element changing the polarization direction; and
a second attenuation element decreasing the energy.

2. A laser output apparatus as claimed in claim 1, wherein the first attenuation element is a first polarizer, the polarization changing element is a half-wave plate, and the second attenuation element is a second polarizer.

3. A laser output apparatus as claimed in claim 2, wherein the second laser light has a propagation direction and a component, and the second polarizer refracts the component to decrease the energy.

4. A laser output apparatus as claimed in claim 2, wherein the first laser light passes through the first polarizer, the half-wave plate and the second polarizer along the propagation direction.

5. A laser output apparatus as claimed in claim 4, wherein the propagation direction defines a rotating axis, and the first polarizer rotates around the rotating axis and refracts the component of the first laser light to attenuate the first laser light and generate the second laser light.

6. A laser output apparatus as claimed in claim 5, wherein the half-wave plate rotates around the rotating axis to change the polarization direction.

7. A laser output apparatus as claimed in claim 3 further comprising a first rotating base and a second rotating base, wherein the first polarizer and the half-wave plate are respectively configured on the first rotating base and the second rotating base.

8. A laser output apparatus as claimed in claim 7 further comprising a motor and a worm gear, wherein the motor and the worm gear rotate the first rotating base and the second rotating base by gear driving so as to rotate the first polarizer and the half-wave plate respectively configured on the first rotating base and the second rotating base.

9. A laser output apparatus as claimed in claim 8, wherein the motor is a step motor.

10. A laser outputting method, comprising:
providing a first laser light;
attenuating the first laser light to be a second laser light having a first polarization direction and a first energy;
changing the first polarization direction; and
decreasing the first energy.

11. A laser outputting method as claimed in claim 10, wherein the attenuating step further comprises steps of:
splitting the first laser light into a first polarization component and a second polarization component, wherein the second laser light is one of the first polarization component and the second polarization component.

12. A laser outputting method as claimed in claim 11, wherein the first laser light has a second polarization direction, and the splitting step further comprises steps of:
providing a polarizer having a transmission axis;
rotating the polarizer such that there is a relative angle between the second polarization direction and the transmission axis; and
making the first laser light passing through the polarizer to generate the first and the second polarization components.

13. A laser outputting method as claimed in claim 10, wherein the changing step further comprises steps of:
providing a half-wave plate; and
changing the first polarization direction by rotating the half-wave plate.

14. A laser outputting method as claimed in claim 13, wherein the changing step further comprises a step of rotating the half-wave plate by using a motor and a worm gear in a gear driving manner.

15. A laser outputting method as claimed in claim 10, wherein the decreasing step further comprises steps of:
providing a second polarizer; and
decreasing the first energy using the second polarizer.

16. A laser outputting method as claimed in claim 15, wherein the decreasing step further comprises a step of rotating the second polarizer by using a motor and a worm gear in a gear driving manner.

17. A laser outputting method as claimed in claim 10, wherein the decreasing step further comprises a step of taking the energy-decreased second laser light as an output laser.

18. A laser outputting method as claimed in claim 17, wherein the output laser has a lowest energy value, a zero point of energy, a highest energy value, and a highest point of energy, the method further comprising a step of measuring the lowest energy value to determine the zero point of energy, and the highest energy value to determine the highest point of energy using a step motor.
